(19) United States
(12) Patent Application Publication
(10) Pub. No.: US 2006/0241918 A1
(43) Pub. Date: Oct. 26, 2006

(54) Method of computing fir filter coefficient and program for computing same

(76) Inventors: Akinori Nishihara, Tokyo (JP); Saed Samadi, Quebec (CA)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/531,102

(22) PCT Filed: Oct. 14, 2003
(86) PCT No.: PCT/JP03/13132

§ 371 Date: Apr. 11, 2005

Related U.S. Application Data
(60) Provisional application No. 60/418,313, filed on Oct. 15, 2002.

(51) Int. Cl. G06F 17/10

(52) U.S. Cl. 703/2

(57) ABSTRACT

The computer executes a first operation by a first recurrence formula, receiving a filter order (positive integer) of a universal maximally flat FIR filter, the number of zeros at z=−1 (integer equal to or more than zero), and a parameter for a group delay at z=1 (rational number). The first recurrence formula includes parameters for the filter order, the number of zeros, and the group delay, and provides coefficients in Bernstein form representation of a transfer function of a universal maximally flat FIR filter. The computer then executes a second operation composed of additions, subtractions, and division by 2 by a second recurrence formula by using a resultant of the first operation as an initial value to extract impulse response coefficients of the universal maximally flat FIR filter from a resultant of the second operation.

### CROSS REFERENCE TO RELATED APPLICATION

This application is based upon and claims the benefit of priority from the prior U.S. provisional Patent Application No. 60/418,313, filed on Oct. 15, 2002, the entire contents of which are incorporated herein by reference.

### TECHNICAL FIELD

The invention relates to a computational method for impulse response coefficients of a universal maximally flat FIR filter, and to a computational program for the same.

### BACKGROUND ART

More than thirty years have passed since the publication of the seminal paper of O. Herrmann on the design of maximally flat FIR digital filters [1]. Of the body of the related research that has been published since Herrmann's article, the most significant contribution to the theory of lowpass maximally flat FIR filters has been Baher's results on the design of filters with simultaneous conditions on amplitude and group-delay response [2]. In recent years, it has been recognized that Baher's filters form a unifying class of maximally flat filters. This class encompasses various types of seemingly distinct systems [3]. Calling this class of filters the universal maximally flat digital filters, the authors simplified Baher's formula for the transfer function and showed that lowpass filters of even or odd lengths, with linear or nonlinear phase response characteristics, as well as fractional delay and half-band filters may be readily obtained by setting the design parameters in an appropriate manner.

Not withstanding universal maximally flat digital filters have an explicit formula for their transfer functions and, thus, may be readily designed using a computer algebra system, the simplified formulas provided in [3] are still unwieldy. A direct use of the formulas involves computation of binomial coefficients with possibly non-integer indices that appear as terms of the summand in a three-fold sum. Binomial coefficients with non-integer indices cannot be computed by the simple method of Pascal's triangle. Another common problem with computations involving the binomial coefficients is due to their tendency to introduce very large integers to the intermediate steps of the computation. With the flexible computer power today, this may not be a serious impediment in many situations. However, there can be cases where limitations on hardware and software resources dictate the use of efficient means in computation of filter coefficients. It is desirable that such methods be free of binomial coefficients and have a simple iterative structure. Moreover, it is known that if the design parameter associated with the group delay is limited to rational numbers, as is the case with many realistic settings, the values of the impulse response coefficients are rational numbers. In such cases, it is important to ensure that the answer to the numerical problem in computation of an impulse response coefficient is exactly a fraction, say ⅓, not a floating number that may be shown as “0.333333335”. Therefore, it is desirable for a computation algorithm to maintain this property of the impulse response coefficients and yield rational values for rational design parameters.

### THE FOLLOWING ARE PRIOR ART REFERENCES RELATED TO THE PRESENT INVENTION

[1] O. Herrmann, “On the approximation problem in nonrecursive digital filter design,” IEEE Trans. Circuit Theory, vol.CT-18, no. 3, pp. 411-413, May 1971.

[2] H. Baher, “FIR digital filters with simultaneous conditions on amplitude and delay,” Electron. Lett., vol. 18, pp 296-297, 1982.

[3] S. Samadi, A. Nishihara and H. Iwakura, “Universal maximally flat lowpass FIR systems,” IEEE Trans. Signal Processing, vol. 48, pp. 1956-1964, 2000.

[4] R. L. Graham, D. E. Knuth and O. Patashnik, Concrete Mathematics. Addison-Wesley, 1989.

### DISCLOSURE OF INVENTION

An object of invention is to compute impulse response coefficients of the universal maximally flat FIR filter efficiently in a short period of time.

According to one aspect of the present invention, the computer executes a first operation by a first recurrence formula, receiving a filter order (positive integer) of a universal maximally flat FIR filter, the number of zeros at z=−1 (integer equal to or more than zero), and a parameter for a group delay at z=1 (rational number). The recurrence formula includes parameters the filter order, the number of zeros, and the group delay, and provides coefficients in Bernstein form representation of a transfer function of a universal maximally flat FIR filter.

The first recurrence formula, for example, is expressed as
bⱼ′=(−1){(2d)bⱼ₋₁′+(j−1)bⱼ₋₂′}/(N−j+1) where 1≦j≦N with b₀′=1 and b₋₁′=0,
in which the filter order is N, the parameter for the group delay is d, the coefficients in Bernstein form representation of a transfer function of the universal maximally flat FIR filter are bⱼ′. The resultant of the first operation is expressed as B′={1,b₁′, . . . ,b_{N-K}′,0, . . . ,0} where the number of zeros is K.

Using a resultant of the first operation as an initial value, the computer executes the second operation by the second recurrence formula composed of additions, subtractions, and divisions by 2 to extract impulse response coefficients of the universal maximally flat FIR filter.

The second recurrence formula, for example, is expressed as
hᵢ^{(p)}=(1+E)hᵢ^{(p-1)}/2+(1−E)hᵢ₋₁^{(p-1)}/2 where 1≦p≦N, 0≦i≦p with h₀⁽⁰⁾=B′ and h₋₁^{(p)}={0, . . . ,0},
in which a sequence for computing impulse response coefficients of the universal maximally flat FIR filter is expressed as hᵢ^{(p)}=(h_{i,j}^{(p)})=(h_{i,0}^{(p)},h_{i,1}^{(p)}, . . . ), and an arbitrary sequence Aᵢ is expressed as E^{j}=E (E^{j-1}Aᵢ), E¹Aᵢ=EAᵢ=Aᵢ₊₁, E⁰Aᵢ=Aᵢ in which a forward shift operator satisfying the expression is E. The impulse response coefficients extracted from the resultant of the second operation are expressed as
hᵢ=h_{i,0}^{(N)} where 0≦i≦N.

### BRIEF DESCRIPTION OF DRAWINGS

FIG. 1 illustrates steps of introducing a computational algorithm for impulse response coefficients according to the present invention.

FIG. 2 illustrates steps of proving the proposition 1.

FIG. 3 illustrates steps of proving the corollary 1.

FIG. 4 illustrates an overview of the computational algorithm for the impulse response coefficients according to the present invention.

FIG. 5 is a flowchart showing the computational algorithm for the impulse response coefficients.

FIG. 6 is a program list of the computational algorithm for the impulse response coefficients executed by computer.

### BEST MODE FOR CARRYING OUT THE INVENTION

The embodiments of the present invention will be described with reference to the drawings in the following.

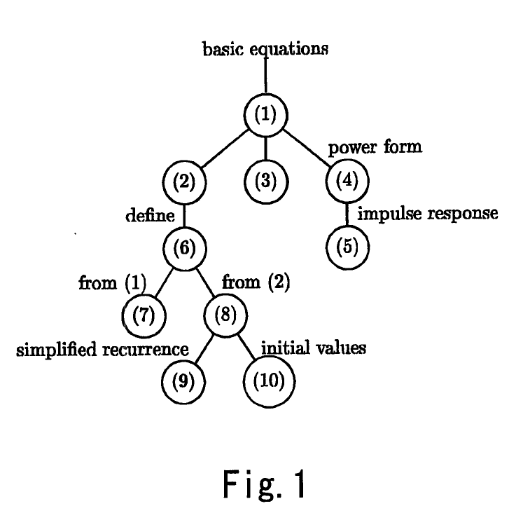

First, a description will be made on mathematical underpinning of the computational algorithm for the impulse response coefficients according to the present invention. FIG. 1 illustrates steps of introducing the computational algorithm for the impulse response coefficients.

It was shown in [3] that the transfer function of the universal maximally flat digital filters, a family of filters identical to those proposed by Baher [2], is given by

$${H}_{N , K , d} ( z ) = {\sum }_{0 \leq j \leq N - K} {{b}_{j} ( \frac{1 - {z}^{- 1}}{2} )}^{j} {( \frac{1 - {z}^{- 1}}{2} )}^{N - j} , \qquad ( 1 )$$

where the coefficients bⱼ are characterized by the three-term recurrence
jbⱼ+2dbⱼ₋₁−(j−N−2)bⱼ₋₂=0, j≧1, (2)
with the initial values
b₀=1 and b₋₁=0. (3)

By converting (1) to the power form representation

$${H}_{N , K , d} ( z ) = {\sum }_{0 \leq k \leq N} {h}_{k} {z}^{- k} \qquad ( 4 )$$

the impulse response coefficients hₖ become [3]

$${h}_{k} = {\sum }_{0 \leq j \leq N - K} {\sum }_{0 \leq p \leq k} {\sum }_{0 \leq i \leq j} \frac{{( - 1 )}^{j - i + p} ( \begin{matrix}\frac{N}{2} - d \\ i\end{matrix} ) ( \begin{matrix}\frac{N}{2} + d \\ j - i\end{matrix} ) ( \begin{matrix}j \\ p\end{matrix} ) ( \begin{matrix}N - j \\ k - p\end{matrix} )}{{2}^{N}} , \\ k = 0 , … , N . \qquad ( 5 )$$

Obviously, (5) is a computationally expensive formula. To ameliorate this situation, devised is an algorithm that exploits the combination of (1) and (2) to compute hₖ for k=0, . . . ,N.

First, (1) is written in the traditional Bernstein form by introducing the sequence bⱼ′ defined by

$${b}_{j}^{′} {=}^{def} \{ \begin{matrix}\frac{{b}_{j}}{( \begin{matrix}N \\ j\end{matrix} )} & 0 \leq j \leq N , \\ 0 , & otherwise .\end{matrix} \qquad ( 6 )$$

Then obtained is

$${H}_{N , K , d} ( z ) = {\sum }_{0 \leq j \leq N - K} {b}_{j}^{′} ( \begin{matrix}N \\ j\end{matrix} ) {( \frac{1 - {z}^{- 1}}{2} )}^{j} {( \frac{1 + {z}^{- 1}}{2} )}^{N - j} . \qquad ( 7 )$$

This is the Bernstein form of the transfer function in the traditional sense. Although (7) has an additional binomial coefficient compared to (1), we will see later that the introduction of bⱼ′ results in considerable simplification.

A recurrence for bⱼ′ is obtained by substituting (6) into (2) and dividing both sides by jⱼ₍ⱼ^{N})≠0.

Thus,

$${b}_{j}^{′} + 2 d \frac{( \begin{matrix}N \\ j - 1\end{matrix} )}{j ( \begin{matrix}N \\ j\end{matrix} )} {b}_{j - 1}^{′} - ( j - N - 2 ) \frac{( \begin{matrix}N \\ j - 2\end{matrix} )}{j ( \begin{matrix}N \\ j\end{matrix} )} {b}_{j - 2}^{′} = 0 , 1 \leq j \leq N . \qquad ( 8 )$$

The above recurrence can be simplified by invoking the definition of the binomial coefficients [4] and a few simple algebraic steps. It follows that

$${b}_{j}^{′} = \frac{- 2 d}{N - j + 1} {b}_{j - 1}^{′} - \frac{j - 1}{N - j + 1} {b}_{j - 2}^{′} , 1 \leq j \leq N , \qquad ( 9 )$$

with the initial values
b′₀=1 and b′₋₁=0. (10)
Thus, for given values of N and d the values of bⱼ′ can be computed recursively by (9).

The next step is to convert (7) to the power form (4) and obtain the impulse response coefficients. A direct expansion of the summand in (7) using the binomial theorem will introduce additional sums and new binomial coefficients. Hence, this is not a desirable action to take. The other alternative is to use a conversion identity well known in the mathematics literature and in the field of computer-aided geometric design. The identity is based on taking successive differences of the Bernstein coefficients. We state this identity as a proposition and provide a proof for it.

(Proposition 1)

Allow the Bernstein form of the polynomial p(x)=Σ_{0≦i≦N}pᵢxⁱ to be given by

$$\begin{matrix}p ( x ) = {\sum }_{0 \leq i \leq N} {b}_{i} ( \begin{matrix}N \\ i\end{matrix} ) {{x}^{i} ( 1 - x )}^{N - i} . \\ Then & ( 11 ) \\ {p}_{i} = ( \begin{matrix}N \\ i\end{matrix} ) {Δ}^{i} {b}_{0} , i = 0 , … , N , & ( 12 )\end{matrix}$$

where the operator Δ is the forward difference operator.

The forward difference operator is defined by the general recurrence
Δ^{j}bᵢ=Δ(Δ^{j-1}bᵢ), (13)
together with
Δ¹bᵢ=Δbᵢ=bᵢ₊₁−bᵢ, Δ⁰bᵢ=bᵢ. (14)

For instance, Δb₀=b₁−b₀ and Δ²b₀=b₂−2b₁+b₀. In this notation, the operator acts on the indices, written as subscripts, of the members of a sequence. To prove the proposition, we also need the forward shift operator E. The effect of E on the index i of a sequence like bᵢ is specified by
E^{j}bᵢ=E(E^{j-1}bᵢ). (15)
together with
E¹bᵢ=Ebᵢ=bᵢ₊₁, E⁰bᵢ=bᵢ. (16)
E is related to Δ by
Δ=E−1. (17)
(Proof of Proposition 1)

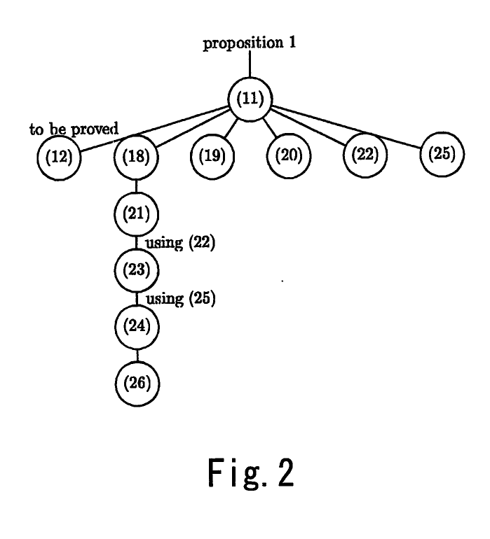

FIG. 2 illustrates steps of proving the proposition 1. Starting with the Bernstein form of p(x) and expand the term (1−x)^{N-i} using the binomial theorem to obtain

$$p ( x ) = {\sum }_{0 \leq i \leq N} {\sum }_{0 \leq j \leq N - i} {( - 1 )}^{N - i - j} {b}_{i} ( \begin{matrix}N \\ i\end{matrix} ) ( \begin{matrix}N - i \\ j\end{matrix} ) {x}^{N - j} . \qquad ( 18 )$$

By the symmetry of the binomial coefficients and the trinomial revision property [4], obtained is

$$( \begin{matrix}N \\ i\end{matrix} ) ( \begin{matrix}N - i \\ j\end{matrix} ) = ( \begin{matrix}N \\ j\end{matrix} ) ( \begin{matrix}N - j \\ N - i - j\end{matrix} ) . \qquad ( 19 )$$

On the other hand
bᵢ=Eⁱb₀. (20)

Thus, it can be written as

$$p ( x ) = {\sum }_{0 \leq i \leq N} {\sum }_{0 \leq j \leq N - i} {( - 1 )}^{N - i - j} ( \begin{matrix}N \\ j\end{matrix} ) ( \begin{matrix}N - j \\ N - i - j\end{matrix} ) {x}^{N - j} {E}^{i} {b}_{0} . \qquad ( 21 )$$

The ranges for the indices of the two-fold sum above may be interchanged as

$${\sum }_{0 \leq i \leq N} {\sum }_{0 \leq j \leq N - i} = {\sum }_{0 \leq j \leq N} {\sum }_{0 \leq i \leq j} \qquad ( 22 )$$

with no effect on the value of the sum. Now, N−j is substituted for j in the sum, and obtained is

$$\begin{matrix}p ( x ) = {\sum }_{0 \leq N - j \leq N} {\sum }_{0 \leq i \leq j} {( - 1 )}^{N - i - ( N - j )} ( \begin{matrix}N \\ N - j\end{matrix} ) ( \begin{matrix}N - ( N - j ) \\ N - i - ( N - j )\end{matrix} ) \\ {x}^{N - ( N - j )} {E}^{i} {b}_{0} .\end{matrix} \qquad ( 23 )$$

The right side above simplifies to

$${\sum }_{0 \leq j \leq N} {\sum }_{0 \leq i \leq j} {( - 1 )}^{j - i} ( \begin{matrix}N \\ j\end{matrix} ) ( \begin{matrix}j \\ j - i\end{matrix} ) {x}^{j} {E}^{i} {b}_{0} . \qquad ( 24 )$$

Note that

$${\sum }_{0 \leq i \leq j} {( - 1 )}^{j - i} ( \begin{matrix}j \\ j - i\end{matrix} ) {x}^{j} {E}^{i} {b}_{0} = {( E - 1 )}^{j} {b}_{0} . \qquad ( 25 )$$

It then follows that

$$p ( x ) = {\sum }_{0 \leq j \leq N} {x}^{j} ( \begin{matrix}N \\ j\end{matrix} ) {( E - 1 )}^{j} {b}_{0} \qquad ( 26 )$$

that is the power form representation of p(x). From the uniqueness of the power from representation of a polynomial and the relation between the operators E and Δ it follows that pᵢ=(ᵢ^{N}) Δⁱb₀. (the end of the proof)

Now presented is a main and last result in this preparatory phase before proceeding to the derivation of the algorithm.

(Corollary 1)

The transfer function H_{N,K,d}(z) is given by

$${H}_{N , K , d} ( z ) = {( \frac{1 + E}{2} + \frac{1 - E}{2} {z}^{- 1} )}^{N} {b}_{0}^{′} . \qquad ( 27 )$$

(Proof of Corollary 1)

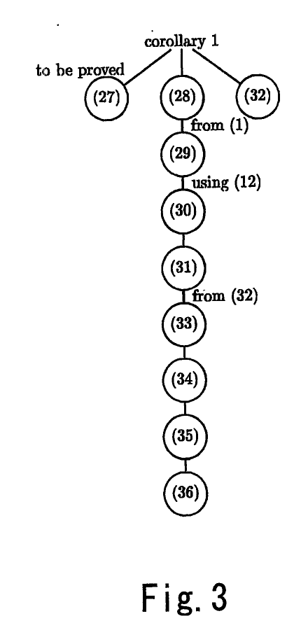

FIG. 3 illustrates steps of proving the corollary 1.

Let
z⁻¹=1−2x. (28)
Then, it can be written that

$${H}_{N , K , d} ( x ) = {\sum }_{0 \leq j \leq N - K} {b}_{j}^{′} ( \begin{matrix}N \\ j\end{matrix} ) {{x}^{j} ( 1 - x )}^{N - j} . \qquad ( 29 )$$

By the above proposition obtained is

$${H}_{N , K , d} ( x ) = {\sum }_{0 \leq j \leq N} ( \begin{matrix}N \\ j\end{matrix} ) {Δ}^{j} {b}_{0}^{′} {x}^{j} . \qquad ( 30 )$$

By substituting for x in terms of z⁻¹ in the above relation and expanding the summand using the binomial theorem, obtained is

$${H}_{N , K , d} ( z ) = {\sum }_{0 \leq j \leq N} ( \begin{matrix}N \\ j\end{matrix} ) {Δ}^{j} {b}_{0}^{′} {\sum }_{i \leq j} ( \begin{matrix}j \\ i\end{matrix} ) {2}^{- j} {( - {z}^{- 1} )}^{i} . \qquad ( 31 )$$

By the trinomial revision identity obtained is

$$( \begin{matrix}N \\ j\end{matrix} ) ( \begin{matrix}j \\ i\end{matrix} ) = ( \begin{matrix}N \\ i\end{matrix} ) ( \begin{matrix}N - i \\ j - i\end{matrix} ) . \qquad ( 32 )$$

The sum indices can also be modified to write

$${H}_{N , K , d} ( z ) = {\sum }_{0 \leq i \leq N} ( \begin{matrix}N \\ i\end{matrix} ) {( \frac{- Δ {z}^{- 1}}{2} )}^{i} {\sum }_{i \leq j} {2}^{- ( j - i )} ( \begin{matrix}N - i \\ j - i\end{matrix} ) {Δ}^{j - i} {b}_{0}^{′} . \qquad ( 33 )$$

Using p=j−i as an index for the second sum, obtained is

$${H}_{N , K , d} ( z ) = {\sum }_{0 \leq i \leq N} ( \begin{matrix}N \\ i\end{matrix} ) {( \frac{- Δ {z}^{- 1}}{2} )}^{i} {\sum }_{0 \leq p \leq N - i} ( \begin{matrix}N - i \\ p\end{matrix} ) {( \frac{Δ}{2} )}^{p} {b}_{0}^{′} . \qquad ( 34 )$$

This simplifies to

$${H}_{N , K , d} ( z ) = {\sum }_{0 \leq i \leq N} ( \begin{matrix}N \\ i\end{matrix} ) {( \frac{- Δ {z}^{- 1}}{2} )}^{i} {( 1 + \frac{Δ}{2} )}^{N - i} {b}_{0}^{′} . \qquad ( 35 )$$

Invoking the binomial theorem further makes it possible to write

$${H}_{N , K , d} ( z ) = {( 1 + \frac{Δ}{2} - \frac{Δ}{2} {z}^{- 1} )}^{N} {b}_{0}^{′} . \qquad ( 36 )$$

By using the relation between Δ and E, (27) follows. (the end of the proof)

Next a description will be made on details of the computational algorithm for the impulse response coefficients according to the present invention.

The algorithm consists of two major stages. In the first stage, by running the recurrence (9) from j=1 up to j=N−K, the following sequence is obtained.
B′=(1,b′₁. . . ,b′_{N-K}, 0, . . . ,0). (37)

The entries bⱼ′ of B′ for N−K<j≦N are set to zero. The next step is to expand the transfer function using (27). This can be done by noting that

$$\begin{matrix}{( \frac{1 + E}{2} + \frac{1 - E}{2} {z}^{- 1} )}^{p} {b}_{0}^{′} = ( \frac{1 + E}{2} + \frac{1 - E}{2} {z}^{- 1} ) \\ ( {( \frac{1 + E}{2} + \frac{1 - E}{2} {z}^{- 1} )}^{p - 1} {b}_{0}^{′} )\end{matrix} \qquad ( 38 )$$

for arbitrary integer p>0. Evaluation of both sides above in the power form yields

$${\sum }_{i} {h}_{i}^{( p )} {z}^{- i} = ( \frac{1 + E}{2} + \frac{1 - E}{2} {z}^{- 1} ) {\sum }_{i} {h}_{i}^{( p - 1 )} {z}^{- i} , \qquad ( 39 )$$

where hᵢ^{(p)} is a sequence of coefficients defined by
hᵢ^{(p)}=(h_{i,j}^{(p)})=(h_{i,0}^{(p)},h_{i,1}^{(p)}, . . . ), (40)
and operator E effects a forward shift on the index j. Thus, it is obtained that

$${\sum }_{i} {h}_{i}^{( p )} {z}^{- i} = {\sum }_{i} ( \frac{1 + E}{2} {h}_{i}^{( p - 1 )} {z}^{- i} + \frac{1 - E}{2} {h}_{i}^{( p - 1 )} {z}^{- i - 1} ) . \qquad ( 41 )$$

It follows that

$${h}_{i}^{( p )} = \frac{1 + E}{2} {h}_{i}^{( p - 1 )} + \frac{1 - E}{2} {h}_{i - 1}^{( p - 1 )} . \qquad ( 42 )$$

The ranges for i and p are specified by
1≦p≦N, 0≦i≦p. (43)

The initial values are given by
h₀⁽⁰⁾=B′₁, h₋₁^{(p)}=(0, 0, . . . ). (44)

This completely specifies the recurrence we use in the second stage of our algorithm. After completing the Nth step, at the point when p has reached N, the value of the i-th impulse response coefficient is given by
hᵢ=fist term of sequence hᵢ^{(N)}, i=0, . . . , N. (45)

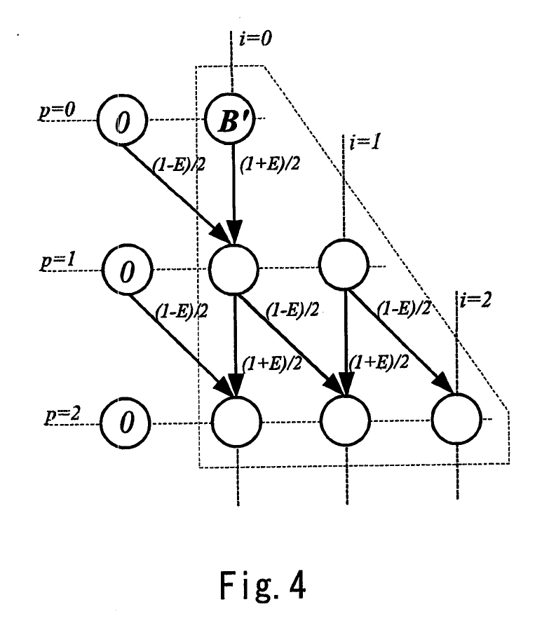

FIG. 4 illustrates an overview of the computational algorithm for the impulse response coefficients according to the present invention. In FIG. 4, each node represents a sequence hᵢ^{(p)}. The nodes marked by 0's represent zero sequences. The recurrence is illustrated in FIG. 4 for N=3 and an unspecified value of K. It can be visually verified that the recurrence has a triangular structure.

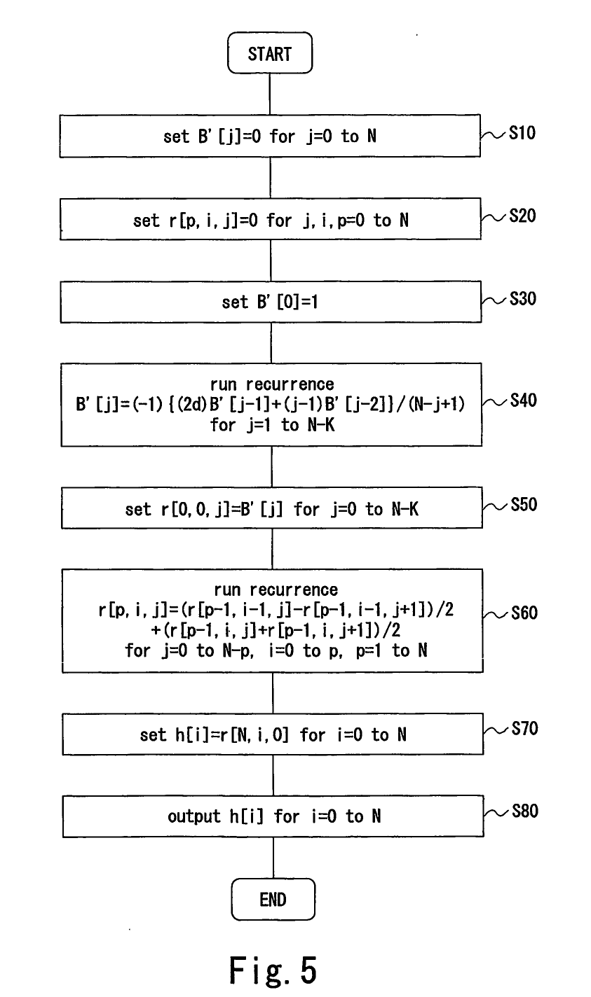

FIG. 5 is a flowchart showing the computational algorithm for the impulse response coefficients according to the present invention.

Receiving a filter order N (positive integer) of the universal maximally flat FIR filter, a number of zeros K (integer equal to or more than zero) at z=−1, and a parameter d (rational number) for a group delay at z=1, the computer computes impulse response coefficients according to the following steps.

In step S10, all of N+1 elements B′[j] (0≦j≦N) of a single-dimension array B′ are initialized to zero. In step S20, all of N³ elements r[p,i,j] (0≦p≦N, 0≦i≦N , 0≦j≦N) of a three-dimension array r are initialized to zero. In step S30, an element B′[0] of the single-dimension array B′ is set to 1.

In step S40, every element of the single-dimension array B′ is decided by changing in sequence an index j from 1 to N−K in a recurrence formula B′[j]=(−1)×{(2d)B′[j−1]+(j−1)B′[j−2]}/(N−j+1). That is, the operation by the recurrence formula (9) is executed.

In step S50, elements r[0,0,j] (0≦j≦N−K) of the three-dimension array r are set to elements B′[j] (0≦j≦N−K) of the single-dimension array B′.

In step S60, every element of the three-dimension array r is decided by sequentially changing, in the order of indexes j, i, p, an index j from zero to N-p, and an index i from zero to p, an index p from 1 to N in a recurrence formula r[p,i,j]=(r[p−1,i−1,j]−r[p−1,i−1,j+1])/2+(r[p−1,i,j]+r[p−1,i,j+1])/2. That is, the operation by the recurrence formula (42) is executed.

In step S70, N+1 elements h[i] (0≦i≦N) of a single-dimension array h are set to elements r[N,i,0] (0≦i≦N) of the three-dimension array r.

In step S80, the single-dimension array h is output as impulse response coefficients of the universal maximally flat FIR filter. This completes the computational processing of the impulse response coefficients by the computer.

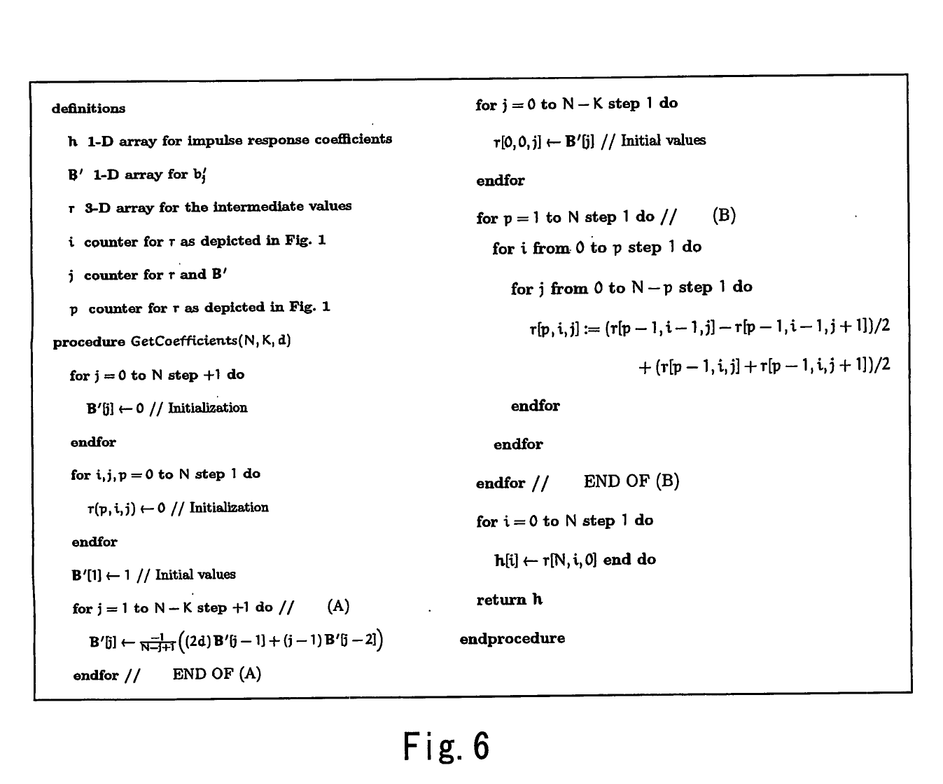

FIG. 6 illustrates a program list of the computational algorithm for the impulse response coefficients by computer. A pseudo-code of a procedure that returns the value of impulse response coefficients as an array is given in FIG. 6.

The following example helps elucidate the details. Let N=3, K=1 and d=(−1)/4. The actual values of the sequences hᵢ^{(p)}, i=0, . . . ,3, corresponding to the 3-D array r in the procedure of FIG. 6, are as follows:

| | h₀^{(p)} | h₁^{(p)} | h₂^{(p)} | h₃^{(p)} | |
|---|---|---|---|---|---|
| p = | (1, ⅙, − 11/24, 0) | | | | |
| 0: | | | | | |
| p = | ( 7/12, − 7/48, − 11/48) | ( 5/12, | | | (46) |
| 1: | | 5/16, − 11/48) | | | |
| p = | ( 7/32, − 3/16) | ( 35/48, 1/12) | ( 5/96, | | |
| 2: | | | 13/48) | | |
| p = | ( 1/64) | ( 39/64) | ( 31/64) | (− 7/64) | |
| 3: | | | | | |

Only non-zero values of the sequences hᵢ^{(p)}, i=1, . . . ,3, are presented. Note that all computations have been done in the field of rational numbers in an exact manner. Hence, round-off errors are avoided.

As described above, an alternative representation for the transfer function of universal maximally flat FIR filters enables the development of a very simple algorithm for evaluation of the impulse response coefficients of the filters. The alternative form of the transfer function is based on the shift operator E and is derived from a technique referred to as finite calculus in [4].

The algorithm consists of two stages. In the first stage a two-term recurrence relation is used to obtain a 1-D sequence of numbers. If the value of the group delay parameter d is a rational number, then the outputs of the recurrence are rational. The outputs are then used in a simple N-step algorithm of triangular structure. In each step of this algorithm, the values of the sequences obtained in the preceding step undergo simple additions, subtractions and divisions by 2 to yield sequences that are shorter in size. Upon the completion of the Nth step, N sequences are obtained. The first entries of these sequences are the values of the impulse response coefficients. As long as the computations in the second stage are done in the field of rational numbers, the final values remain rational. This provides an accurate and fast means for exact computation of the impulse response coefficients.

Here, a worst-case analysis of the computational complexity of the present algorithm will be described.

The computational complexity may be analyzed by evaluating the complexity of the simple for-loop marked by (A) and the nested for-loop designated by (B) in FIG. 6. For the number of additions and subtractions C_{±}, it is obtained that

$${C}_{\pm } = {\sum }_{1 \leq j \leq N - K} 4 + {\sum }_{1 \leq p \leq N} {\sum }_{0 \leq i \leq p} {\sum }_{0 \leq j \leq N - p} 3. \qquad ( 47 )$$

For a closed-form expression, note that

$${C}_{\pm } = 4 ( N - K ) + 3 {\sum }_{1 \leq p \leq N} {\sum }_{0 \leq i < p + 1} ( N - p + 1 ) , \qquad ( 48 )$$

that can be evaluated as

$${C}_{\pm } = 4 ( N - K ) + 3 {\sum }_{0 \leq p < N} ( p + 2 ) ( N - p ) . \qquad ( 49 )$$

Thus, obtained is

$${C}_{\pm } = 4 ( N - K ) + 3 ( \frac{5}{6} N + {N}^{2} + \frac{1}{6} {N}^{3} ) . \qquad ( 50 )$$

For the number of multiplications C* obtained is

$${C}_{*} = {\sum }_{1 \leq j \leq N - K} 2 = 2 ( N - K ) . \qquad ( 51 )$$

The number of divisions C_{/} is given by

$${C}_{/} = {\sum }_{1 \leq j \leq N - K} 1 + {\sum }_{1 \leq p \leq N} {\sum }_{0 \leq i \leq p} {\sum }_{0 \leq j \leq N - p} 2. \qquad ( 52 )$$

that becomes

$${C}_{/} = ( N - K ) + 2 ( \frac{5}{6} N + {N}^{2} + \frac{1}{6} {N}^{3} ) . \qquad ( 53 )$$

In comparison, for the direct evaluation using (5), the number of additions and subtractions C_{±}^{Direct} is

$${C}_{\pm }^{Direct} > {\sum }_{0 \leq j \leq N - K} {\sum }_{0 \leq p \leq k} {\sum }_{0 \leq i \leq j} 1 \qquad ( 54 )$$

The right side above is of the order O(N⁴). The number of multiplications C*^{Direct}, on the other hand, is

$${C}_{*}^{Direct} > {\sum }_{0 \leq j \leq N - K} {\sum }_{0 \leq p \leq k} {\sum }_{0 \leq i \leq j} jk . \qquad ( 55 )$$

The right side above is of the order O(N⁵). For the number of divisions C_{/}^{Direct} in a direct evaluation, it can be written in

$${C}_{/}^{Direct} > {\sum }_{0 \leq j \leq N - K} {\sum }_{0 \leq p \leq k} {\sum }_{0 \leq i \leq j} 4. \qquad ( 56 )$$

The right side above, again, is of order O(N⁴). Thus, in addition to the simplicity of most of the division operations in the present algorithm (that are divisions by 2), a significant reduction in the overall complexity is accommodated in terms of sheer numbers.

The invention is not limited to the above embodiments and various modifications may be made without departing from the spirit and scope of the invention. Any improvement may be made in part or all of the components.

### INDUSTRIAL APPLICABILITY

As described above, the impulse response coefficients of the universal maximally flat FIR filters may be computed efficiently using a two-stage algorithm. For a filter of order N with K zeros at z=−1, the first stage of the algorithm uses a two-term recurrence to generate a sequence of length N−K+1. This sequence undergoes an N-step iterative process that involves additions, subtractions and divisions by 2. The algorithm does not involve any form of binomial coefficients. Moreover, the algorithm requires less number of arithmetical operations compared to a direct evaluation using the closed-form formula. The algorithm is mostly suitable for real-time generation of the coefficients on a DSP chip because it may be easily implemented in a computational environment that has restrictions on the available hardware or software resources.

What is claimed is:

1. A method of computing FIR filter coefficients, comprising the steps of:
inputting a filter order of a universal maximally flat FIR filter, a number of zeros at z=−1, and a parameter for a group delay at z=1, the filter order being a positive integer, the number of zeros being an integer equal to or more than zero, the parameter being a rational number;
executing a first operation by a first recurrence formula which includes parameters for the filter order, the number of zeros, and the group delay, and provides coefficients in Bernstein form representation of a transfer function of the universal maximally flat FIR filter;
executing a second operation by a second recurrence formula composed of additions, subtractions, and divisions by 2, by using a resultant of the first operation as an initial value; and
extracting impulse response coefficients of the universal maximally flat FIR filter from a resultant of the second operation.

2. The method according to claim 1, wherein:
the first recurrence formula is expressed as
bⱼ′=(−1){(2d)bⱼ₋₁′+(j−1)bⱼ₋₂′}/(N−j+1) where 1≦j≦N with b₀′=1 and b₋₁′=0,
wherein the filter order is N the parameter for the group delay is d, coefficients in Bernstein form representation of a transfer function of the universal maximally flat FIR filter are bⱼ′;
the resultant of the first operation is expressed as B′={1,b₁′, . . . ,b_{N-K}′,0, . . . ,0}, wherein the number of zeros is K;
the second recurrence formula is expressed as
hᵢ^{(p)}=(1+E)hᵢ^{(p-1)}/2+(1−E)hᵢ₋₁^{(p-1)}/2 where 1≦p≦N, 0≦i≦p with h₀⁽⁰⁾=B′ and h₋₁^{(p)}={0, . . . ,0},
wherein a sequence for computing impulse response coefficients of the universal maximally flat FIR filter is expressed as hᵢ^{(p)}=(h_{i,j}^{(p)})=(h_{i,0}^{(p)},h_{i,1}^{(p)}, . . . ), and an arbitrary sequence Aᵢ is expressed as Eⁱ=E(E^{j-1}Aᵢ), E¹Aᵢ=EAᵢ=Aᵢ₊₁, E⁰Aᵢ=Aᵢ in which a forward shift operator satisfying the expression is E; and
the impulse response coefficients extracted from the resultant of the second operation are expressed as hᵢ=h_{i,0}^{(N)} where 0≦i≦N

3. A program for computing FIR filter coefficients, the program causing a computer to execute the steps of:
determining every element of a single-dimension array B′ using a filter order N being a positive integer of a universal maximally flat FIR filter, a number of zeros K at z=−1, K being an integer equal to or more than zero, and a parameter d for a group delay at z=1, d being a rational number, all of which are provided by inputs, by changing in sequence an index j from 1 to N−K in a recurrence formula B′[j]=(−1)×{(2d)B′[j−1]+(j−1)B′[j−2]}/(N−j+1), the single-dimension array having N+1 elements B′[j] where 0≦j≦N, in which an element B′[0] thereof is initialized to 1 and all the elements thereof except the element B′[0] are initialized to zero;
determining every element of a three-dimension array r by sequentially changing, in the order of indexes j, i, p, an index j from 0 to N-p, and an index i from 0 to p, an index p from 1 to N in a recurrence formula r[p,i,j]=(r[p−1,i−1,j]−r[p−1,i−1,j+1])/2+(r[p−1,i,j]+r[p−1,i,j+1])/2, the three-dimension array r having N³ elements r[p,i,j] where 0≦p≦N, 0≦i≦N, 0≦j≦N, in which elements r[0,0,j] thereof where 0≦j≦N−K are initialized to elements of the single-dimension array B′[j] where 0≦j≦N−K, and all the elements thereof except the elements r[0,0,j] are initialized to zero; and
extracting elements r[N,i,0] of the three-dimension array r where 0≦i≦N as the impulse response coefficients of the universal maximally flat FIR filter.
